(19) United States
(12) Patent Application Publication
(10) Pub. No.: US 2011/0292448 A1
(43) Pub. Date: Dec. 1, 2011

(54) PROGRAM EXECUTION CONTROL METHOD

(75) Inventor: Hiroshi OHASHI, Hino-shi (JP)

(73) Assignee: Konica Minolta Business Technologies, Inc., Chiyoda-ku (JP)

(21) Appl. No.: 13/115,747

(22) Filed: May 25, 2011

(30) Foreign Application Priority Data
May 28, 2010 (JP) 2010-123453

(51) Int. Cl. G06K 15/02

(52) U.S. Cl. 358/1.16

(57) ABSTRACT

A program execution control method for a printer provided with a controller including a CPU, a RAM and a ROM, wherein a first program to be operated in a printing state, a second program to be operated in a sleep state and a third program to be operated in a standby state are stored in the ROM, the program execution control method includes the steps of: executing by the CPU, in the printing state, the first program by expanding the first program on the RAM, and by using a work area of the RAM; executing by the CPU, in the sleep state, the second program without expanding the second program on the RAM, and without using the work area of the RAM; and executing by the CPU, in the standby state, the third program without expanding the third program on the RAM, and by using the work area of the RAM.

### CROSS REFERENCE TO RELATED APPLICATION

This application is based on Japanese Patent Application No. 2010-123453 filed on May 28, 2010 with Japanese Patent Office, the entire content of which is hereby incorporated by reference.

### BACKGROUND OF THE INVENTION

1. Technical Field

The present invention relates to a program execution control method and particularly to a program execution control method for a printer where a program to be operated in printing state and a program to be operated in sleep state are executed.

2. Description of Prior Art

In an apparatus that controls an operation by a program, usually a control section configured with a CPU (Central Processing Unit) and a memory such as a RAM (Random Access Memory), ROM (Read Only Memory) is provided. And the program stored in the ROM is expanded on the RAM to be executed on the CPU.

In cases of using a DRAM (Dynamic RAM) which being low cost as the RAM, a refresh operation is required for keeping data in the DRAM in conjunction with read-write operation in the DRAM. Due to this, power consumption of the DRAM is low in a condition of no accessing, but increases at the time of read-write operation and refresh operation, and increases in accordance with the number of times of accessing.

For this problem, Unexamined Japanese Patent Application Publication No. H07-334278 (Patent Document 1) discloses a method of suppressing the power consumption, wherein in a MPU operation using a control program downloaded in a second memory such as the DRAM requiring high power consumption, even after completion of starting up process of the apparatus, a specific program module, for example an idle program, included in a first memory such as the ROM requiring low power consumption is used in order to suppress the usage time of the program module on the second memory requiring high power consumption.

By using the above described technology of Patent Document 1, the power consumption of the memory in idling mode can be reduced, however according to the above technology, it is difficult to properly reduce the power consumption in various operating conditions of various types of apparatuses.

For example, in an apparatus such as a printer having complicated mechanisms of driving section and heating section and the like, it is required to operate the apparatus in a condition of making said mechanisms standby state in order to enable immediate execution of printing at the time of receiving print data. While, since the printer is always in power ON condition, in cases where nonuse state has continued for a certain time period, it is required to operate the printer in the sleep state.

In this way, since the operating condition of the printer differs among printing state, standby state and sleep state, it is required to properly operate the program according to each operating condition. However, since the technology of Patent Document 1 does not take into consideration of program attributes such as a processing scale to be realized by the program (amount of information to be temporarily stored at the time of processing) and a processing speed, even if this technology is applied to the apparatus such as the printer, it is difficult to properly reduce the power consumption.

The present invention is achieved in view of the above described problem, and main object of the invention is to provide a program execution control method which enables to reduce the power consumption by properly utilizing the memories in accordance with the operating conditions of the apparatus.

### SUMMARY OF THE INVENTION

In order to achieve the above described object, a method reflecting an aspect of the present invention is a program execution control method for a printer provided with a controller including a CPU, a RAM and a ROM, wherein a first program to be operated in a printing state, a second program to be operated in a sleep state and a third program to be operated in a standby state are stored in the ROM, the program execution control method including the steps of: executing by the CPU, in the printing state, the first program by expanding the first program on the RAM, and by using a work area of the RAM; executing by the CPU, in the sleep state, the second program without expanding the second program on the RAM, and without using the work area of the RAM; and executing by the CPU, in the standby state, the third program without expanding the third program on the RAM, and by using the work area of the RAM.

### BRIEF DESCRIPTION OF THE DRAWINGS

These and other objects, advantages and features of the invention will become apparent from the following description thereof taken in conjunction with the accompanying drawings in which:

FIG. 1 is a drawing schematically illustrating the configuration of a printer and a controller relating to an embodiment of the present invention; and

FIG. 2 is a diagram of a flow chart illustrating program execution procedures for the printer relating to an embodiment of the present invention.

### DETAILED DESCRIPTION OF THE PREFERRED EMBODIMENT

In recent years, apparatuses are required of reducing power consumption, and a technology is disclosed where reduction of power consumption is tried by using a ROM which being low power consuming, in idling mode. While, in the conventional printer, programs are executed even in a sleep state where high speed processing is not required by using a work area of RAM, similarly to the case of high speed processing, therefore the power consumption is not sufficiently reduced.

To be more specific, amounts of power consumption of ROM and RAM are quite different, and the RAM largely differs in power consumption depending on its operation conditions. For example, the approximate power consumption of the ROM is 0.1 W, and that of RAM is approximately 0.72 W at the time of operating, 0.36 W at the standby state, and 0.036 W at the time of self-refreshing. Therefore, if a program is executed in the sleep state by using a RAM work area, the power consumption will be increased.

Therefore, according to an embodiment of the present invention, in apparatuses such as a printer provided with complicated mechanisms and being operated under various conditions, in order for enabling the proper reduction of power consumption, utilizing methods of RAM and ROM are made changeable in view of attributes of the programs being operated under various conditions.

For example, a program to be operated at the time of printing state (having a large processing scale and required of high speed processing using a RAM work area) is expanded on a RAM and executed by use of the RAM work area. A program to be operated at the time of standby state (a medium processing speed program having a medium processing scale and required of using a RAM work area) is stored in a ROM and executed by use of the RAM work area. Further, a program to be operated at the time of sleep state (a low processing speed program having a small processing scale and executable by a register of CPU), is stored in a ROM and executed without using the RAM work area (by using a register).

In this way, by making settable of which of RAM or ROM the program is stored in, and whether to use or not to use the RAM work area at the time of operating the program, the power consumption of the printer can be effectively reduced.

Regarding the RAM, in cases of using DDR2 which being high-performance and low power consumption, further reduction of power consumption can be attained by setting a self-refresh mode than the case of DDR (Double Data Rate) utilizing both rising and trailing times of clock signals at the time of synchronizing between each circuits in the computer.

### EMBODIMENT

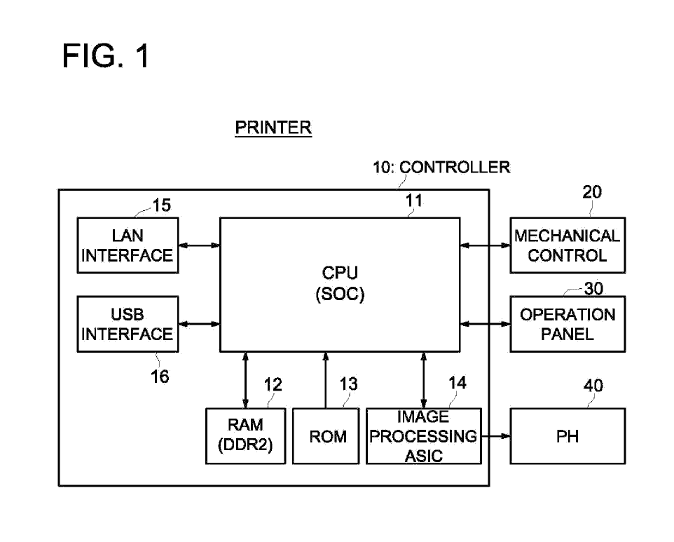

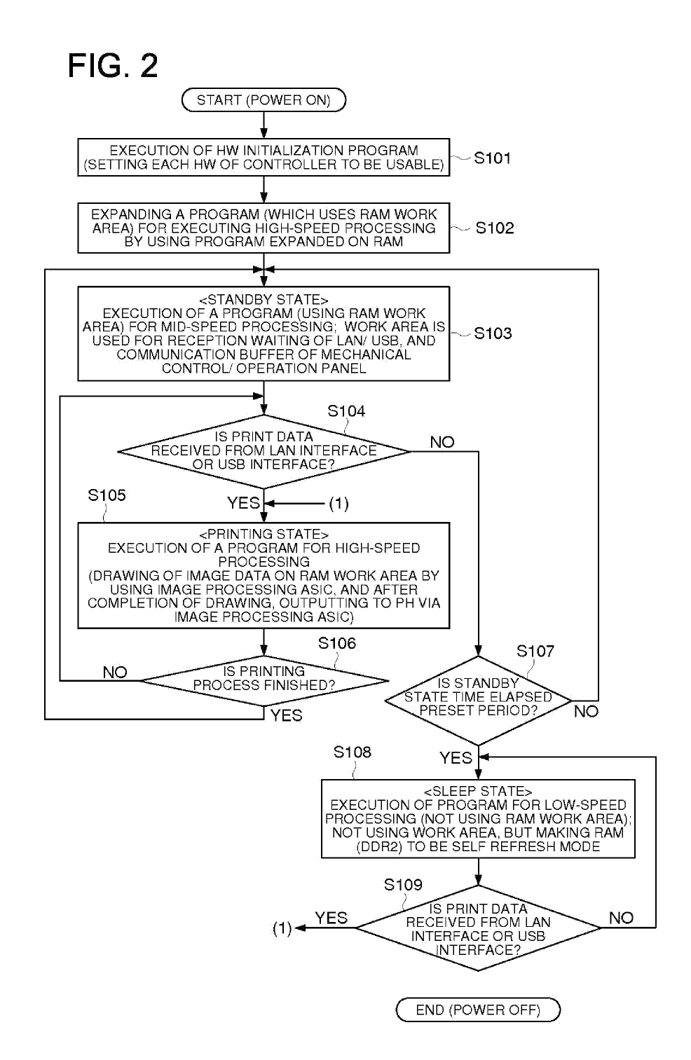

In order to explain an embodiment of the above described present invention in further detail, a program execution control method relating to the embodiment of the present invention will be described by referring to FIGS. 1 and 2. FIG. 1 is a drawing schematically illustrating the configuration of a printer and a controller of the present embodiment; and FIG. 2 is a diagram of a flow chart illustrating the operation of the printer. Although, in the present embodiment a printer is described as the example, the embodiment is applicable generally to image processing apparatuses such as a scanner apparatus, a FAX apparatus, and an MFP (Multi function Peripheral).

As shown in FIG. 1, a printer of the present embodiment is configured with controller 10, and mechanical control 20, operation panel 30, PH (Printer Hardware) 40 those connected to controller 10.

Controller 10 is configured with CPU (SOC: System-on-a-Chip) 11, RAM (DDR2) 12, ROM 13, image processing ASIC (Application Specific Integrated Circuit) 14, LAN (Local Area Network) interface 15, USB (Universal Serial Bus) interface 16, and the like. CPU 11 is connected to mechanical control 20 and operation panel 30, and also connected to image processing ASIC 14 and PH 40.

CPU 11 is a section to execute the program stored in ROM 13 or expanded on RAM 12, and configured with an operational device such as an ALU (Arithmetic Logic Unit), a register to temporarily memorize data, an interface to a storage device such as a memory, an interface to input/output device of peripheral apparatuses, control device to totally control the CPU, and the likes. Wherein, the register is a circuit that, by using circuit elements such as a flip-flop, temporarily stores a computing result, stores addresses in cases of read/write a main memory such as RAM 12 and ROM 13, and keeps or changes the operation state of a processor or a peripheral apparatus.

RAM 12 is a memory device where operations of reading-out and writing-in are capable for memory cells of arbitral addresses, by inputting address information via address signals. The RAM is broadly divided into DRAM and SRAM (Static RAM), and in the present embodiment the DRAM which being low-cost is used. The DRAM keeps memorized data as electric charges in a capacitor, and the data is lost by natural discharges after a certain time period. Due to this, in order to keep the information, the information needs to be periodically read-out and written-in again (refresh operation). For example, by the frequency of some dozens times per second, the refresh operation is repeated in order to keep the memory.

RAM 12 is provided with an area for expanding program, and an area capable of write/read (referred as work area). CPU 11 expands the program requiring high-speed processing stored in ROM 13 for example on RAM 12, executes drawings of image data on the work area by utilizing image processing ASIC 14, and after completion of the drawing outputs to PH 40 via image processing ASIC 14.

Rom 13 is a memory device exclusive to read-out, and broadly divided into a mask ROM and a PROM (Programmable ROM). Programs described below are stored in ROM 13.

1. Initialization program of controller 10 (uncompressed)
2. Program that operates (executes low speed processing) in sleep state (uncompressed)
3. Program that operates (executes medium speed processing) in standby state (uncompressed)
4. Program that operates (executes high speed processing) in printing state (uncompressed or compressed)
5. Program to expand the program if item 4 on RAM 12 (uncompressed)

The program of item 2 for executing the low speed program mainly executes waiting for LAN/USB receiving interruption. The program of item 3 for executing the medium speed program mainly executes waiting for LAN/USB receiving, and communication with mechanical control 20 and panel 30.

Image processing ASIC 14 is an integrated circuit that for example converts inputted RGB image data to CMY data, and executes image processing such as area separation, black creation, color correction based on CMY data of pixel unit.

LAN interface 15 is configured of NIC (Network Interface Card) and the like, and by connecting the printer with a communication network establishes communications with a client computer devices.

USB interface 16 establishes communications with devices (for example, a digital camera) complying with USB standard which being one of serial bus standard, and with recording media (for example, a USB memory).

Mechanical control 20 is a control system that executes mechanical controls for ensuring reliability and performance of the machine.

Operation panel 30 is configured with a pressure sensitive operation section (touch panel) where transparent electrodes are arranged in lattice pattern on a display section.

PH 40 is such as a print section of a printer, and is a printing mechanism configures with such as a photosensitive drum, a charging unit, an exposure unit, a developing unit, a transfer unit, and a fixing unit.

FIG. 1 shows an example of a printer, and as far as controller 10 is provided with CPU 11, RAM 12, and ROM 13, the configuration may be arbitrarily changeable. For example the configuration may be such that by providing a memory means such as an HDD (hard Disk Drive), storing a high speed processing program and the like, and at the time of starting the apparatus, reading out said program from the HDD to store into RAM 12.

Execution procedures of the program in the above mentioned configuration will be described by referring to the flow chart of FIG. 2.

First, when an electric power of the apparatus is put on, an initialization program is executed to make settings such that each hardware (HW) of CPU 11, RAM 12, ROM 13, image processing ASIC 14, LAN interface 15, and USB interface 16 is ready for use (S101).

Next, to execute a program for expanding the program stored in ROM 13 on RAM 12, CPU 11 reads out a program to be executed at the time of printing (a program requiring of the work area of RAM 12 to execute a high-speed processing) from RAM 12, and expands on RAM 12 (S102).

At this stage, the printer enters to a standby state, and CPU 11 executes a program to be executed at the standby state (a program requiring of the work area of RAM 12 to execute a medium-speed processing), (S103). In this case, CPU 11 executes this program without expanding on RAM 12, however CPU 11 uses the work area of RAM 12 as reception waiting buffers for LAN interface 15 and USB interface 16, and as communication buffers for mechanical control 20 and operation panel 30.

On this standby status, CPU 11 monitors the receiving of print data from LAN interface 15 or USB interface 16 (S104), and on receiving the print data CPU 11 executes the program expanded on RAM 12 in step S102 (the program requiring of the work area of RAM 12 to execute a high-speed processing), (S105). In this case, CPU 11 executes a drawing of image data on the work area of RAM 12 by using image processing ASIC 14, and after completion of the drawing, outputs the drawing data to PH 40 via image processing ASIC 14.

When the printing processing is finished (S106: Yes), the process returns to the standby state of S103, and if not finished (S106: No), returns to S104 to wait the receiving of print data.

If the print data is not received in S104, determines whether standby state time period has elapsed a preset period (S107), and if not returns to S103 to keep the standby state.

On the other hand, if the standby state time elapsed the preset period, by transitioning to a sleep state, CPU 11 executes the program for a low-speed processing (the program executable by registers of CPU 11), (S108). In this case CPU 11 does not use the work area of RAM 12, and makes RAM 12 to be self refresh mode to refresh itself.

In this sleep state, monitoring receptions of print data from LAN interface 15 and USB interface 16 (S109), if the print data is not received, returns to S108 to keep the sleep state, and if receives the print data, transitions to S105 to become printing state.

And, the above described procedures are executed until the electric power is shut off.

As described above, according to the present embodiment, the program to be operated at the time of printing state (for example, a high processing speed program) is stored in RAM 12 and executed by using the work area of RAM 12, the program to be operated at the time of standby state (for example, a medium processing speed program) is stored in ROM 13 and executed by using the work area of RAM 12, and the program to be operated at the time of sleep state (for example, a low processing speed program) is stored in ROM 13 and executed without using the RAM work area, therefore, the power consumption is effectively reduced.

Although the above described embodiment, the control method for a printer is explained, the present invention is not restricted to the above embodiment, and may be similarly applied to any arbitrary apparatus in which a program to use a work area of RAM 12 and a program not to use the work area of RAM 12 are selectively executed.

The present invention is usable for apparatuses that execute programs by using CPU, RAM and ROM, and particularly for printers in which a program to use a work area of RAM 12 and a program not to use the work area of RAM 12 are selectively executed.

According to the program execution control method of the present invention, by properly using memories in accordance with operation conditions of an apparatus, the power consumption is reduced.

The reason is that: according to the program execution control method of the present invention, in the state such as the sleep state, where a program executable by registers of CPU (program having a small processing scale, and sufficiently operated with low processing speed) is operated, said program is stored in the ROM and executed without using the RAM; and in the state such as the printing state, where a program having a large processing scale and requiring the RAM work area (program requiring high processing speed) is operated, said program is expanded on the RAM and executed by using the RAM work area.

Further, according to the program execution control method of the present invention, in the state such as the standby state, where a program having an intermediate processing scale between the high processing speed and the low processing speed programs and requiring the RAM work area (program requiring medium processing speed) is operated, said program is stored in the ROM and executed by using the RAM work area.

What is claimed is:

1. A program execution control method for a printer provided with a controller including a CPU, a RAM and a ROM, wherein a first program to be operated in a printing state, a second program to be operated in a sleep state and a third program to be operated in a standby state are stored in the ROM, the program execution control method comprising the steps of:
executing by the CPU, in the printing state, the first program by expanding the first program on the RAM, and by using a work area of the RAM;
executing by the CPU, in the sleep state, the second program without expanding the second program on the RAM, and without using the work area of the RAM; and
executing by the CPU, in the standby state, the third program without expanding the third program on the RAM, and by using the work area of the RAM.

2. The program execution control method of claim 1, wherein the CPU executes the second program by using a register in the CPU.

3. The program execution control method of claim 1, wherein the CPU refreshes the RAM at a time of executing the second program.

4. The program execution control method of claim 1, wherein the first program is required of higher processing speed compared to the second program.

5. The program execution control method of claim 3, wherein the CPU establishes a self refresh mode of the RAM, and refreshes the RAM.
